(19) United States
(12) Patent Application Publication
(10) Pub. No.: US 2005/0026478 A1
(43) Pub. Date: Feb. 3, 2005

(54) Solder bearing conductive terminal

(76) Inventor: Chun-Hsiang Chiang, Taipei Hsien (TW)

Correspondence Address: MOLEX INCORPORATED, 2222 WELLINGTON COURT, LISLE, IL, 60532, US

(21) Appl. No.: 10/891,668

(22) Filed: Jul. 15, 2004

(30) Foreign Application Priority Data
Jul. 16, 2003 (TW) 92213018

(51) Int. Cl. H01R 12/00

(52) U.S. Cl. 439/83

(57) ABSTRACT

A conductive terminal is disclosed to be positioned in an insulative body to constitute an electrical connector. The insulative body is formed with a first face and a second face opposite to the first face. The conductive terminal is formed with a contact end projecting outwardly of the first face, and a solder end projecting outwardly of the second face. The contact end is disposed to electrically connect with an electronic component. A distal edge of the solder end is formed into a fork shape for electrical connection with a circuit board through a solder material. When the solder end contacts the corresponding solder material, the solder end and the surface of the solder material can form at least two contact points to prevent change of relative positions of the solder end and the solder material and to facilitate piercing of the solder end into the solder material when the solder material is softened such that the solder material can be positioned on the solder end in an encapsulating manner after cooling and curing thereof.

### FIELD OF THE INVENTION

This invention relates to a conductive terminal, and more particularly, to a conductive terminal for positioning fusible material, such as solder, thereon.

### BACKGROUND OF THE INVENTION

It is known that chips such as central processing units (CPU) will have more and more electrical contacts for external signal input/output (I/O) due to the trend of development toward increasingly powerful processing speeds and functionality, but they are required to be compact in size and light in weight after packaging. Therefore, packaging methods such as PGA (Pin Grid Array), BGA (Ball Grid Array), or even LGA (Land Grid Array) are adopted for the packaging of integrated circuit chips such as central processing units that have high-density designs. However, no matter which method is adopted for packaging integrated circuit chips, an electrical connector must be used to electrically connect the integrated circuit chips with a circuit board. Therefore, in order that the electrical connector can match the packaging of the integrated circuit chip, and in consideration of the stability of the electrical connection between the electrical connector and the circuit board, as well as processing efficiency, a method of achieving electrical connection between the electrical connector and the circuit board which is widely adopted today is to have one end of each conductive terminal within the electrical connector connected to a corresponding solder ball, and to solder the electrical connector to the circuit board using surface mounting technique (SMT).

Reference is made to FIG. 1, which shows a PGA-packaged central processing unit 7 connected to a circuit board 9 through an electrical connector 8. The packaged central processing unit 7 has a plurality of downwardly projecting pins 71 that are arranged equidistantly apart from one another in a certain area on a bottom surface thereof. The electrical connector 8 includes an insulative body 81 and a plurality of receiving holes 82 corresponding in position to the pins 71 and extending through upper and lower surfaces of the insulative body 81. Each receiving hole 82 receives a conductive terminal 83 therein. In addition, the circuit board 9 is pre-configured to have electrical contacts 91 corresponding in position to the conductive terminals 83. The upper ends of the conductive terminals 83 within the insulative body 81 electrically contact the corresponding pins 71 of the central processing unit 7, whereas the lower ends thereof are correspondingly connected to the electrical contacts 91 on the circuit board 9 such that the central processing unit 7 can be electrically connected to the circuit board 9 for transmission of electrical signals.

Referring to FIG. 2, as mentioned hereinabove, in order that the lower end of the conductive terminal 83 can be connected to the circuit board 9 by surface mounting technique, the lower end of the conductive terminal 83 must be connected to a solder ball 84 in advance, and the solder ball 84 attached to the lower end of the conductive terminal 83 is subjected to reflow after contact with the circuit board 9, whereby the conductive terminal 83 and the circuit board 9 can be electrically connected through the solder ball 84. However, how to precisely attach the solder ball 84 to the lower end of the conductive terminal 83 in advance requires the solving of many problems associated with the manufacturing process in practice, one of which is the positioning of the solder ball 84.

As shown, a currently adopted method is to form a mating surface 813, which is communicated with the corresponding receiving hole 82 and which is inwardly recessed like the curve of a sphere, in the insulative body 81. The lower end of the conductive terminal 83 is formed with a support portion 831 for attaching to the mating surface 813 so that the mating surface 813 and the support portion 831 constitute a recess to contact the surface of the solder ball 84. The recess serves to position the solder ball 84, and the solder ball 84 can also electrically contact the support portion 831 of the conductive terminal 83. The aforesaid method is described herein merely as an example. Certainly, other forms can also be employed for the insulative body 81 or the conductive terminal 83 therein, but the essential spirit resides in the change of the insulative body 81 or the end portion of the conductive terminal 83 to form a mechanism that can generate interference with the solder ball 84 for positioning.

As shown in FIG. 3, in response to the change made to the insulative body 81 and the conductive terminal 83 for positioning the solder ball 84 as shown in FIG. 2, during the positioning process of the solder ball 84, a lower surface 812 of the insulative body 81 is turned upside down to face upwardly after the conductive terminal 83 is assembled to the insulative body 81, thereby causing the end of the conductive terminal 83 which is to be connected to the solder ball 83 to be oriented upwardly as well.

Further, a positioning plate 85 is used to cover the lower surface 812 of the insulative body 81. The positioning plate 85 is provided with a plurality of through holes 851 that correspond to the conductive terminals 83 in position and that can permit passage of the solder balls 84 such that the support portions 831 of the conductive terminals 83 can be exposed due to the through holes 851.

Then, the solder balls 84, which are much larger in number than the through holes 851, are caused to move reciprocatingly on the positioning plate 85 so that the solder balls 84 can naturally drop into the through holes 851 by their own weight so as to contact the conductive terminals 83. Surplus solder balls 84 are subsequently removed from the positioning plate 85. Alternatively, the solder balls 84 are disposed in the through holes 851 by other methods so as to contact the conductive terminals 83. Then, steps of solder reflow and removal of the positioning plate 85 are performed so that the solder balls 84 can be interconnected with the conductive terminals 83, thereby achieving the object of precise solder ball positioning.

However, although such a solder ball positioning method can solve the problem of positioning the solder balls 84 and the conductive terminals 83 relative to each other, since the support portions 831 of the conductive terminals 83 are connected to the solder balls 84 by employing surface contact, the stability of connection of the solder balls 84 is not easy to control, and the solder balls 84 may disengage from the conductive terminals 83 if they are not firmly soldered thereto, thereby resulting in defective products.

In view of the drawbacks with conventional electrical connectors and solder materials such as solder balls in the positioning process, the applicant has proposed a preferred solder positioning method, which mainly resides in the use of a solder end of the conductive terminal to pierce into a molten solder ball to achieve connection.

However, as shown in FIG. 5, if the distal edge of a solder end 862 of a conductive terminal 86 is merely formed with a barb having a single point, when the solder end 862 is to be pierced into a corresponding solder ball 84 to achieve connection, since the surface of the solder ball 84 is spherical, contact of the barb-shaped solder end 862 with the surface of the not-yet-melted and slightly hard solder ball 84 will result in only a single contact point. However, a single contact point is not a stable balanced state for the barb-shaped solder end 862 and the solder ball 84, especially when the conductive terminal 86 is subjected to a force to pierce in the direction of the solder ball 84, which is likely to result in deviation of the solder ball 84 to any one lateral side so that there is the phenomenon of deviation of the solder ball 84 after soldering. Therefore, there is a need for further improvement of the shape of the solder end 862 of the conductive terminal 86.

### SUMMARY OF THE INVENTION

Therefore, an object of this invention is to provide a conductive terminal that can contact a solder material stably so as to pierce into the solder material for positioning of the solder material thereon.

The conductive terminal of this invention is disposed to be positioned in an insulative body to constitute an electrical connector. The insulative body is formed with a first face and a second face opposite to the first face. The conductive terminal is formed with a contact end projecting outwardly of the first face and a solder end projecting outwardly of the second face. The contact end is disposed to electrically connect with an electronic component. A distal edge of the solder end is formed into a fork shape for connection with a circuit board through a solder material.

The effect of this invention resides in that, by means of the fork shape formed by the distal edge of the solder end, when the solder end contacts the corresponding solder material, the solder end and the surface of the solder material can form at least two contact points to prevent change of relative positions of the solder end and the solder material and to facilitate piercing of the solder end into the solder material when the solder material is heated and melts. When the solder material is cooled and becomes hardened, it can be positioned on the solder end in an encapsulating manner.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is an exploded perspective view illustrating a form of electrical connection between an electronic component and a circuit board through an electrical connector in practice;

FIG. 2 is a schematic partly sectional view illustrating the connective relationship between a conventional conductive terminal and a solder ball;

FIG. 3 is a schematic view illustrating the arrangement when an electrical connector of FIG. 2 is positioned with solder balls and its assembling relationship when a positioning plate is used;

FIG. 4 is a perspective view illustrating schematically how a conductive terminal with a single point is connected to a solder ball;

FIG. 5 is a schematic side view illustrating the possible state of deviation of the solder ball when the conductive terminal contacts the solder ball;

FIG. 6 is a perspective view illustrating assembly of a conductive terminal according to this invention and an insulative body to constitute an electrical connector in practice;

FIG. 7 is a perspective view of the structure of the conductive terminal;

FIG. 8 is an operational schematic view illustrating the assembling relationship of the electrical connector and a support tray;

FIG. 9 is an operational schematic view with the side partly shown in section to illustrate the contact relationship between a solder end of the conductive terminal and a solder ball prior to softening of the solder ball;

FIG. 10 is a schematic view taken from another angle showing the contact between the solder end of the conductive terminal and the solder ball of FIG. 9;

FIG. 11 is an operational schematic view with the side partly shown in section to illustrate the connective relationship between the solder end of the conductive terminal and the solder ball after softening of the solder ball;

FIG. 12 is a perspective view showing a conductive terminal according to this invention;

FIG. 13 is a perspective view showing a conductive terminal according to this invention; and

FIG. 14 is a perspective view showing a conductive terminal according to this invention.

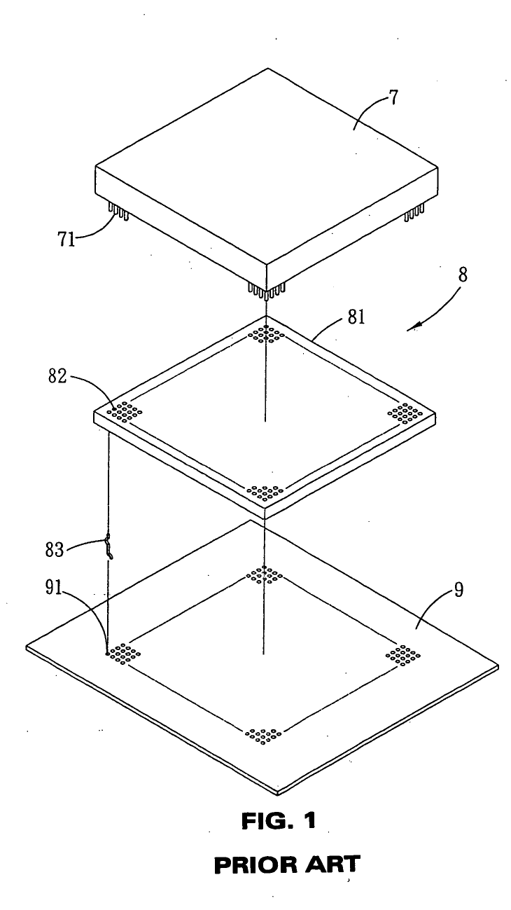

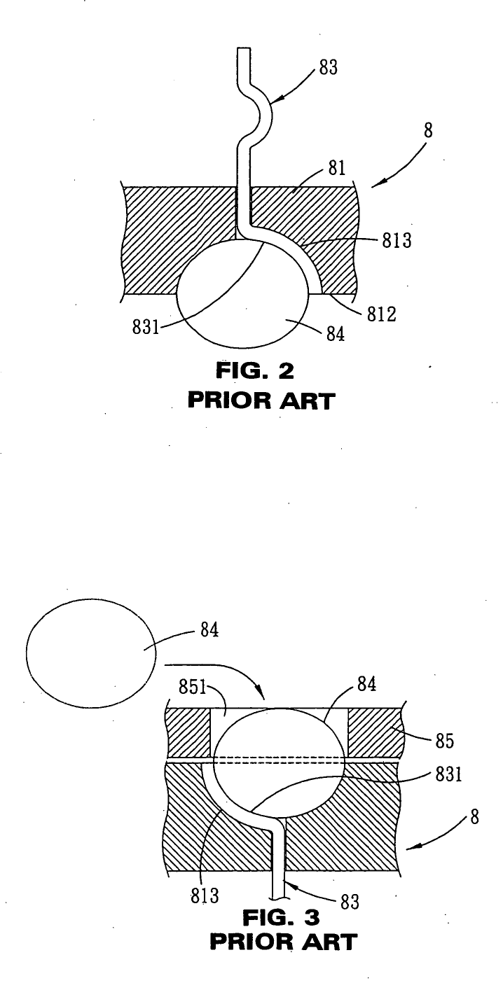

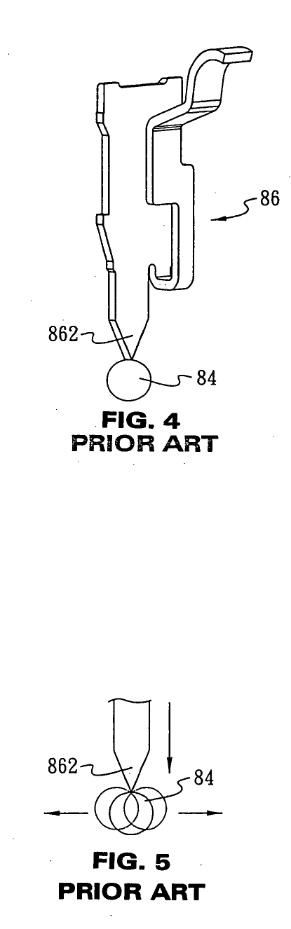

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

The preferred embodiments of the conductive terminal according to this invention will be described by way of a solder positioning method. The method provides soldering between an electrical connector and a plurality of solder materials (not shown) such as tin solder balls. In the description to follow, the form of the solder material is represented by tin solder balls but is not limited thereto in actual practice. Besides, the solder balls are not necessarily spherical in shape, and the method employed for positioning the solder balls on the conductive terminals may not be the method provided by the applicants.

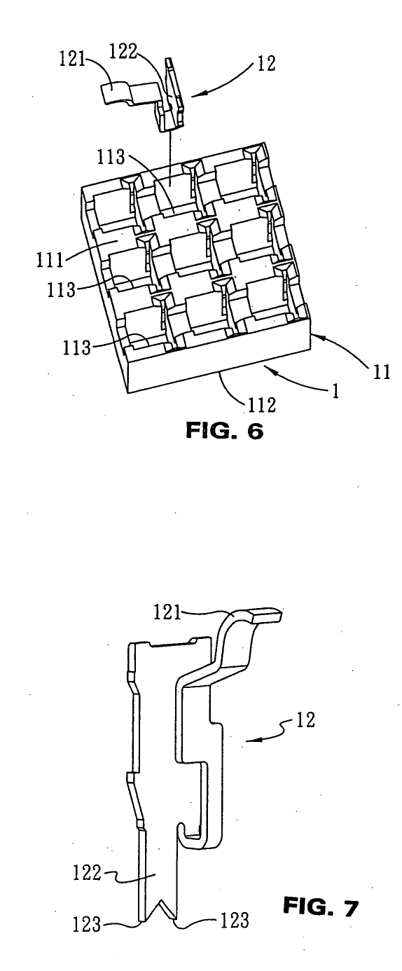

Referring to FIGS. 6 and 7, the first preferred embodiment of this invention is shown in the form of a plurality of conductive terminals 12 (only one conductive terminal 12 is shown in the FIGS.) positioned within an insulative body 11 to constitute an electrical connector 1.

The insulative body 11 is a generally rectangular body, and is formed with a first face 111 and a second face 112 opposite to the first face 111. The insulative body 11 has a plurality of receiving holes 113 provided therein, which extend through the first face 111 and the second face 112. In the FIGS., the insulative body 11 is shown to have a small number of receiving holes 113. The number of the receiving holes 113 depends on the number of the pins or electrical contacts of an electronic component (not shown), such as a central processing unit, to be connected.

The conductive terminal 12 (see FIG. 7) is formed by punching a metal plate, and has a contact end 121 that is bent at a lower end to extend upwardly, and a solder end 122 extending downwardly to be mounted in the receiving hole 113 in the insulative body 11. The contact end 121 is substantially configured into a curved resilient arm, and a distal edge of the solder end 122 is depressed into a triangular shape to form a fork shape having dual pointed portions 123 such that the contact end 121 projects outwardly of the first face 111 to contact the electronic component (not shown), whereas the solder end 122 projects outwardly of the second face 112 to connect with the solder ball to thereby establish electrical connection with a circuit board (not shown).

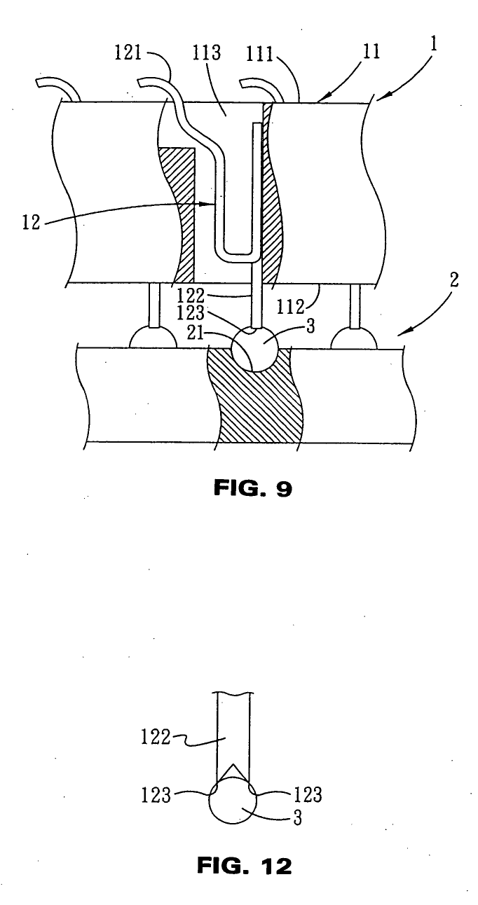

In use, the plurality of conductive terminals 12 are mounted in the insulative body 11 such that the solder ends 122 of the conductive terminals 12 project outwardly of the second face 112 of the insulative body 11 (as shown in FIG. 9), and such that the insulative body 11 is arranged with the first face 111 oriented upwardly and with the second face 112 oriented downwardly.

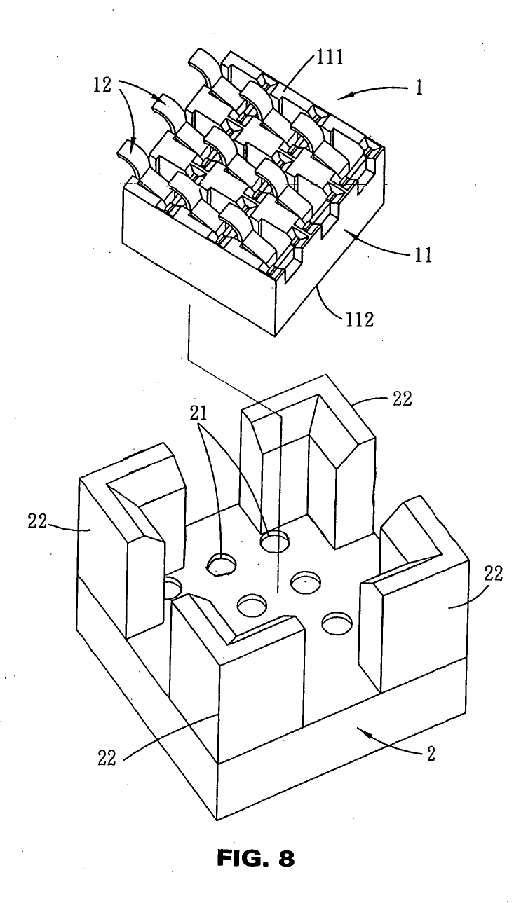

Referring to both FIG. 8 and FIG. 9, a support tray 2 is prepared in advance. An upper surface of the support tray 2 is formed with recesses 21 at positions corresponding to the solder ends 122 of the respective conductive terminals 12 such that each of the recesses 21 receives and positions a solder ball 3. In this embodiment, the recess 21 is formed with a substantially semispherical recessed surface matching the solder ball 3 such that the solder ball 3 can stay in the recess 21 and cannot freely disengage from the recess 21. In addition, the support tray 2 is further provided with four limiting guide blocks 22 on the surface formed with the plurality of recesses 21 so as to match the substantially rectangular shape of the insulative body 11. Each limiting guide block 11 has an L-shaped cross-section projecting upward to a certain distance such that inner lateral sides of each limiting guide block 22 which form a generally 90-degree included angle are substantially oriented towards the center of the shape of the support tray 2. The four limiting guide blocks 22 can all contact correspondingly the edges of the four corners of the rectangular insulative body 11. In other words, the four limiting guide blocks 22 are provided to constitute a moving space for confining the insulative body 11.

Thereafter, the solder ends 122 of the conductive terminals 12 that are mounted in the insulative body 11 are caused to pass through a receiving device (not shown) having a flux present therein such that a certain amount of the flux is applied to the solder ends 122 of the conductive terminals 12.

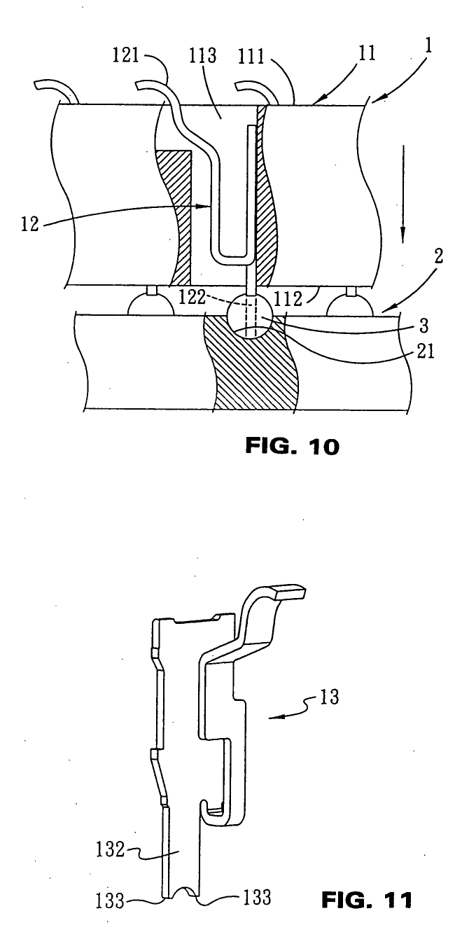

As shown in FIG. 8, the support tray 2 is arranged in a substantially horizontal direction, with the side on which the plurality of solder balls 3 are positioned oriented upwardly. The entire electrical connector 1 is disposed above the support tray 2, with the second face 112 of the insulative body 11 having the solder ends 122 of the plurality of conductive terminals 12 projecting therefrom oriented downwardly. The electrical connector 1 is placed in the moving space formed by the four limiting guide blocks 22 by suction using automated equipment or by manual removal, thereby guiding the insulative body 11 to move in up-and-down directions only and not to move laterally leftward or rightward relative to the support tray 2. When the electrical connector 1 is no longer supported by the automated equipment or manual force, the weight of the electrical connector 1 itself will cause the second face 112 of the insulative body 11 having the plurality of solder ends 122 projecting therefrom to move toward the surface of the support tray 2 having the plurality of solder balls 3 positioned thereon until the two pointed portions 123 at the distal edge of the solder end 122 of the respective conductive terminal 12 contact the surface of the corresponding solder ball 3 (as shown in FIGS. 9 and 10). Since the distal edge of the solder end 122 which has the two pointed portions 123 will simultaneously create two contact points upon contacting the spherical surface of the solder ball 3, the pressure exerted on the surface of the solder ball 3 by the solder end 122 can be uniformly distributed over the pointed portions 123 to achieve a more stable balanced state. Therefore, the solder ball 3 can be prevented from changing relative position relative to the conductive terminal 12 at the instant of contact, thereby ensuring the positioning of the solder ball 3 in the subsequent process.

Finally, the support tray 2 is heated so that the solder balls 3 on the support tray 2 softens or melts. Then, by virtue of the weight of the electrical connector 1 itself, the solder end 122 of each conductive terminal 12 pierces into the corresponding softened or molten solder ball 3 by the action of gravity (as shown in FIG. 11). After the solder ball 3 is cooled and cured, the solder ball 3 encapsulates the solder end 122 of the conductive terminal 12 to achieve firm connection. Then, the electrical connector 1 can be removed from the support tray 2. After separation with the electrical connector 1, the support tray 2 can be recycled for use in the solder positioning process for another electrical connector 1.

Additionally, in the conductive terminal 13 shown in FIG. 12, the solder end 132 is also provided with two pointed portions 133, and differs from the first preferred embodiment merely in that the distal edge of the solder end 132 is curved to form the two pointed portions 133. As the other functions are the same as those in the first preferred embodiment, a description thereof is dispensed with herein for the sake of brevity.

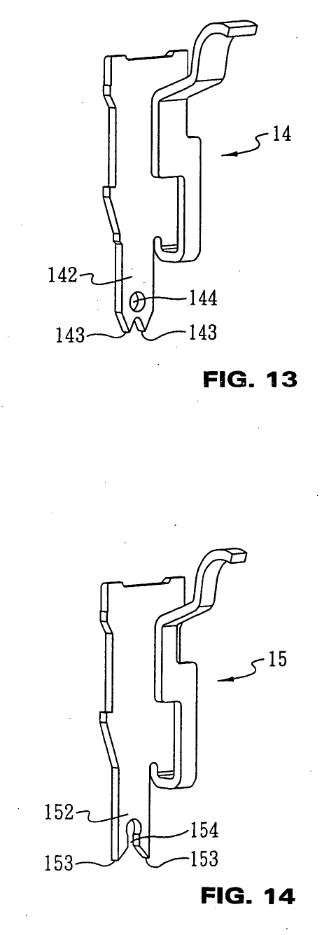

Further, a conductive terminal 14 shown in FIG. 13 has a solder end 142 that is configured into a dual-peak shape to form two pointed portions 143, the function of which is identical to that described hereinabove in connection with the previous embodiments. In addition, the solder end 142 is further provided with a through hole 144. The purpose of providing the through hole 144 is to permit more flux to adhere to the solder end 142 during the process of attachment of the flux, thereby facilitating the connection between the solder end 142 and the solder ball 3. On the other hand, when the solder end 142 pierces into the molten solder ball 3, the material of the solder ball 3 will also penetrate into the through hole 144. After the solder ball 3 has cooled and become hardened, the effect of interference between the solder ball 3 and the solder end 142 can be enhanced considerably to improve the stability of their connection.

Further, in a conductive terminal 15 shown in FIG. 14, apart from having two pointed portions 153, the solder end 152 further has a slot 154 disposed between the two pointed points 153 and extending in an up-and-down direction. The function of the slot 154 is identical to that of the aforesaid through hole 144, i.e., to permit more flux to stick thereto and to enhance the stability of its connection with the solder end 152.

To sum up, by means of the configuration of the shape of the solder end of the conductive terminal of this invention, during contact with the solder material, a balancing state of two contact points can at least be formed such that when the solder end contacts the solder material, deviation of their positions can be prevented to maintain relative positioning and to facilitate subsequent piercing of the solder end into the solder material to achieve connection, thereby achieving the object of this invention.

While a preferred embodiment of the present invention is shown and described, it is envisioned that those skilled in the art may devise various modifications of the present invention without departing from the spirit and scope of the appended claims.

1. A conductive terminal disposed to be positioned in an insulative body to constitute an electrical connector, the insulative body being formed with a first face and a second face opposite to the first face, the conductive terminal being formed with a contact end a solder end, the solder end projecting outwardly of the second face, the contact end being disposed to electrically connect with an electronic component, the solder end being disposed to electrically connect with a circuit board through a solder material, characterized in that:
a distal edge of the solder end is formed with at least two contact points such that when the solder end contacts the corresponding solder material, the at least two contact points prevent change of relative positions of the solder end and the solder material to facilitate piercing of the solder end into the solder ball when the solder material is softened such that the solder material can be positioned on the solder end.

2. The conductive terminal as claimed in claim 1, wherein the solder end may be further provided with a through hole.

3. The conductive terminal as claimed in claim 2, wherein the through hole facilitates attachment of a relatively large amount of flux to permit connection of the solder end with the solder material and penetration of the solder material thereinto after the solder material softens so as to strengthen the stability of connection between the solder material and the solder end.

4. The conductive terminal according to claim 1, wherein the solder end is further provided with a slot.

5. The conductive terminal according to claim 4, wherein the slot facilitates attachment of a relatively large amount of flux to permit connection of the solder end with the solder material and penetration of the solder material thereinto after the solder material melts so as to strengthen the stability of connection between the solder material and the solder end.

6. An electrical connector, comprising:
an insulative housing, the insulative housing having a first face and a second face opposite the second face, and a plurality of receiving holes extending from the first fact to the second face;
a plurality of terminals, each terminal having a contact end and a solder end, wherein the terminal are located in the receiving holes such that solder end extends beyond the second face of the insulative housing in a direction away from the first face of the insulative housing, wherein a distal edge of the solder end is formed with at least two contact points such that when the solder end contacts the corresponding solder material, the at least two contact points prevent change of relative positions of the solder end and the solder material to facilitate piercing of the solder end into the solder ball when the solder material is softened such that the solder material can be positioned on the solder end.

7. The electrical connector as claimed in claim 6, wherein the solder end may be further provided with a through hole.

8. The electrical connector as claimed in claim 7, wherein the through hole facilitates attachment of a relatively large amount of flux to permit connection of the solder end with the solder material and penetration of the solder material thereinto after the solder material softens so as to strengthen the stability of connection between the solder material and the solder end.

9. The electrical connector according to claim 6, wherein the solder end is further provided with a slot.

10. The electrical connector according to claim 9, wherein the slot facilitates attachment of a relatively large amount of flux to permit connection of the solder end with the solder material and penetration of the solder material thereinto after the solder material melts so as to strengthen the stability of connection between the solder material and the solder end.

11. An electrical assembly, comprising:
a printed circuit board;
a connector mounted on the printed circuit board;
an integrated circuit chip received into the connector;
wherein the connector comprises an insulative housing, the insulative housing having a first face and a second face opposite the second face, and a plurality of receiving holes extending from the first fact to the second face, a plurality of terminals, each terminal having a contact end and a solder end, wherein the terminal are located in the receiving holes such that solder end extends beyond the second face of the insulative housing in a direction away from the first face of the insulative housing, wherein a distal edge of the solder end is formed with at least two contact points such that when the solder end contacts the corresponding solder material, the at least two contact points prevent change of relative positions of the solder end and the solder material to facilitate piercing of the solder end into the solder ball when the solder material is softened such that the solder material can be positioned on the solder end.

12. The electrical assembly as claimed in claim 11, wherein the solder end may be further provided with a through hole.

13. The electrical assembly as claimed in claim 12, wherein the through hole facilitates attachment of a relatively large amount of flux to permit connection of the solder end with the solder material and penetration of the solder material thereinto after the solder material softens so as to strengthen the stability of connection between the solder material and the solder end.

14. The electrical assembly according to claim 11, wherein the solder end is further provided with a slot.

15. The electrical assembly according to claim 14, wherein the slot facilitates attachment of a relatively large amount of flux to permit connection of the solder end with the solder material and penetration of the solder material thereinto after the solder material melts so as to strengthen the stability of connection between the solder material and the solder end.
